(19) United States
(12) Patent Application Publication
(10) Pub. No.: US 2021/0127874 A1
(43) Pub. Date: May 6, 2021

(54) Salt ninja

(71) Applicant: William Christopher Martorana, Gilroy, CA (US)

(72) Inventor: William Christopher Martorana, Gilroy, CA (US)

(73) Assignee: William Christopher Martorana, Gilroy, CA (US)

(21) Appl. No.: 16/602,558

(22) Filed: Nov. 1, 2019

(51) Int. Cl. A47G 19/34; A47J 43/28

(52) U.S. Cl. CPC A47G 19/34; A47J 43/28

(57) ABSTRACT

The Salt Ninja is a gimmick product that is intended to be used to add salt your favorite Mexican beer without the hassle and mess. It dispenses salt from a miniature, three-part plastic mechanism to the rim of an upright beer bottle. The product is able to hold and dispense salt with a quick shake of the mechanism and removes the necessity of utilizing a traditional, bulky rim salter and the use of an additional drinking mechanism (glass or cup).

This invention pertains to the entrainment and food industry as well as household culinary appliances. More specifically the alcoholic beverage industry. This product provides the unique and specific task of providing additional culinary experience while consuming beer. The product further allows for the said process to be completed with ease and with speed. The Salt Ninja fully salts the rim of beer bottles which has prior been difficult due to the nature of the beer bottle. The addition of salt may increase the satisfaction of beer allowing for alcohol providing institutions to improve customer service and for households' to thoroughly enjoy their beverage.

To current knowledge, a product of this nature does not exist. Though other rim salting mechanisms do exist, none of these previous products allow for salting of rims for beverages that require drinking directly from the bottle. This makes this product a great addition to the alcoholic beverage industry and will allow for a new take on consuming beer. The salt ninja is a gimmick product that is intended to be used to add salt your favorite Mexican beer without the hassle and mess.

The product is small and comes in three parts. A part that will house the salt, a portion that allows for the device to be attached to the beer and a lid for the device. This allows the device to function properly, store quickly and makes it portable enough to take on the go. It can be thus seen that this product is a novel invention that will provide useful service for the beverage industry and improve customer experience.

### BRIEF SUMMARY OF THE INVENTION

This invention is a small, plastic device that houses and dispenses salt onto the rim of any beer bottle. It contains three distinct parts that allow for the application of salt with ease and without mess or struggle. This product is advantageous because it can be taken on the go, allowing for salt to be applied without transfer to another drinking vessel. It provides additional pleasure to drinking a beer by enhancing the culinary experience of consuming the beverage.

### BRIEF SUMMARY OF DRAWINGS

FIG. 1. Product Base

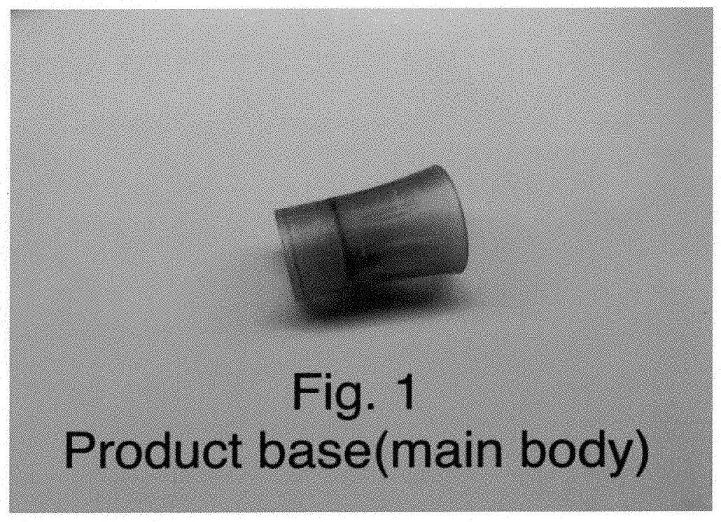

FIG. 2. Attachment portion for rim of the beverage (bottle stop)

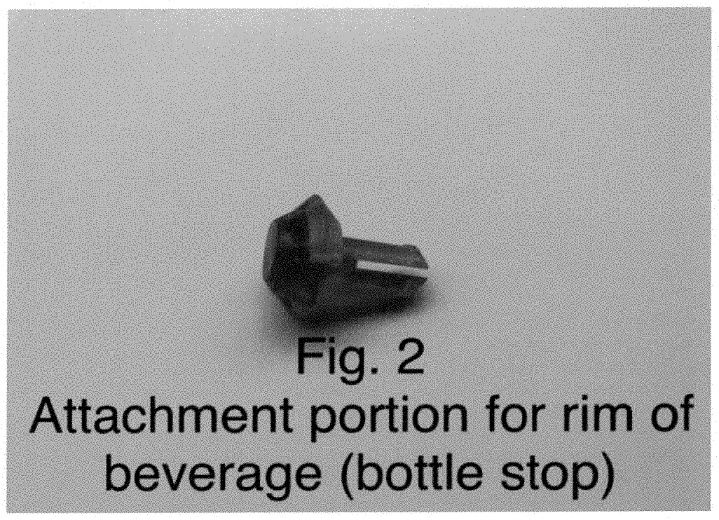

FIG. 3. Lid for the product

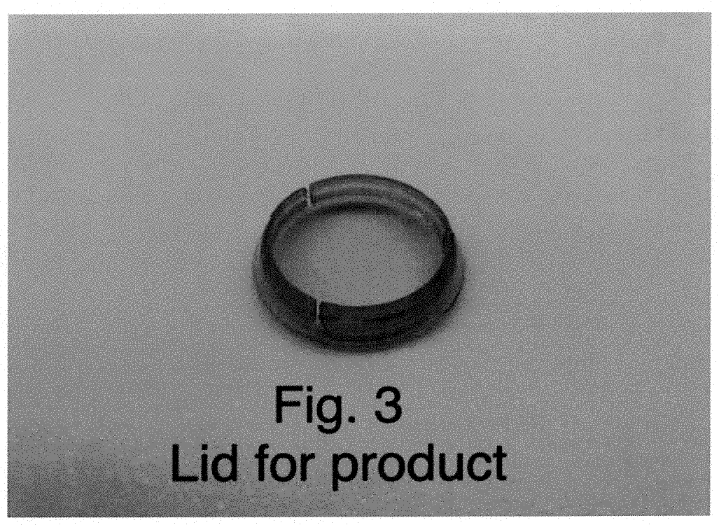

FIG. 4. Salt baffle

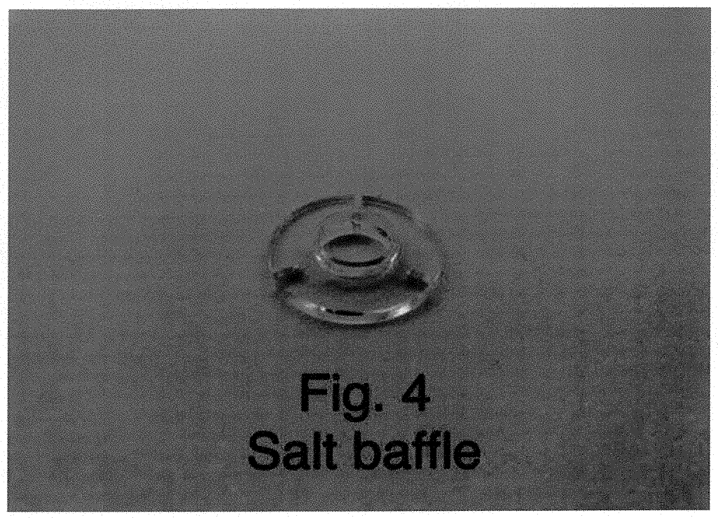

### DETAILED DESCRIPTION OF THE PRODUCT

The Salt Ninja was printed using a the Creality cr-10 FDM 3D printer. The software utilized in this process was the 3D Designed and model in fusion 360 by Autodesk. The product was designed and printed in three parts and to ensure proper function. The product was beta tested and reprinted correcting any functional errors.

To use this product, the Salt Ninja is filled with salt, placed over the rim of the beer bottle and shaken to release the salt. The product itself is the only portion that is shaken, the beer remains stable. This allows for salt to be dispensed without causing fizz to develop in the alcoholic beverage and for salt to be dispensed without spilling the mineral during the process.

The Salt Ninja is then removed from the rim of the bottle and is ready for use. This allows for any excess salt to be utilized during the next use or discarded without any mess. This product can be stored easily in small spaces, accessed easily and transported without the bulk and need for additional glasses as needed with traditional salting mechanisms.

The claimed invention is:

1. i. Plastic with separate parts and
ii. Attachable to the rim of any standard beer bottle
iii. Able to dispense salt to the rim of a standard beer bottle while the bottle remains upright
iv. Approximately three inches in height and
v. Two inches in diameter
vi. Ovular vertically and cyclical
vii. Contains a removal lid and removal portion that can be inserted into the rim of the beer bottle
